(19) United States
(12) Patent Application Publication
(10) Pub. No.: US 2025/0341270 A1
(43) Pub. Date: Nov. 6, 2025

(54) MOLDED INSERT ASSEMBLY FOR A FRACKING HOSE CLAMP, AND A METHOD FOR MANUFACTURING AND ASSEMBLING THEREOF

(71) Applicant: TOPCO OILSITE PRODUCTS LTD., Calgary (CA)

(72) Inventors: Leon Burt, Red Deer (CA); Ryan Goudie, Calgary (CA); Alan Huehn, Calgary (CA); Jason Huehn, Calgary (CA)

(21) Appl. No.: 19/176,863

(22) Filed: Apr. 11, 2025

Related U.S. Application Data
(60) Provisional application No. 63/643,150, filed on May 6, 2024.

(51) Int. Cl. F16L 33/03; E21B 43/26

(52) U.S. Cl. CPC F16L 33/03; E21B 43/2607

(57) ABSTRACT

Disclosed examples relate to a molded insert assembly for a fracking hose clamp, and a method for manufacturing and assembling thereof. In at least one example, the molded insert assembly includes a pair of molded insert portions, each molded insert portion comprising: a forward end and an opposed rear end, extending along an extension axis; a pair of contact surfaces spanning along either lateral side, wherein the contact surfaces extend along a contact plane; each contact surface comprising a tab-receiving groove having an open end defined along the corresponding lateral side; a hose-receiving surface extending, along the lateral axis, between the pair of contact surfaces, and further extending between the forward and rear ends, wherein the hose-receiving surface has a cross-sectional concave profile extending from the contact plane and along a traverse axis; and one or more sloped members, extending from the rear end and contiguous with the hose-receiving surface.

### CROSS-REFERENCE TO RELATED APPLICATION(S)

The present application claims priority to, and the benefit of, U.S. Provisional Patent Application No. 63/643,150, titled “MOLDED INSERT ASSEMBLY FOR A FRACKING HOSE CLAMP, AND A METHOD FOR MANUFACTURING AND ASSEMBLING THEREOF”, filed on May 6, 2024, the entire contents of which are incorporated herein by reference.

### FIELD

Various embodiments are described herein that generally relate to mechanical clamps and brackets used for fracking hoses in oil and gas applications, and in particular, to a molded insert assembly for a fracking hose clamp, and a method for manufacturing and assembling thereof.

### BACKGROUND

Hydraulic fracturing in oil and gas applications rely on high pressure fracking hoses (also known as “frac hoses”). These hoses are positioned above ground and are designed for high pressure fluid suction and discharge. The frac hoses are typically secured in place using large mechanical clamps.

### SUMMARY OF VARIOUS EMBODIMENTS

According to one broad aspect, there is disclosed a molded insert assembly for use with a frac hose clamp, the molded insert assembly comprising a pair of molded insert portions, each molded insert portion comprising: a forward end and an opposed rear end, extending along an extension axis, as well as a first lateral side and a second lateral side opposed along a lateral axis orthogonal to the extension axis; a pair of contact surfaces spanning along either lateral side, wherein the contact surfaces extend along a contact plane; each contact surface comprising a tab-receiving groove having an open end defined along the corresponding lateral side; a hose-receiving surface extending, along the lateral axis, between the pair of contact surfaces, and further extending between the forward and rear ends, wherein the hose-receiving surface has a cross-sectional concave profile extending from the contact plane and along a traverse axis; and one or more sloped members, extending from the rear end and contiguous with the hose-receiving surface, each of the sloped members disposed at an angle to the surface.

According to another broad aspect, there is provided a method of assembling a frac hose clamp with molded insert portions, comprising: coupling a pair of molded insert portions, to a corresponding pair of clamp members of the frac hose clamp; overlaying a frac hose along the hose-receiving surface of one of the coupled molded insert portions; and assembling the clamp members to form the clamp with a molded insert assembly therein, wherein in an assembled state, the frac hose extends through a hose insertion aperture of the molded insert assembly.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a perspective view of an example frac hose clamp in an assembled state.

FIG. 2A is a rear elevation view of the example frac hose clamp of FIG. 1.

FIG. 2B is a schematic illustration of a clamp member in an unassembled state.

FIG. 3A is a perspective view of a frac hose clamp with a molded insert assembly therein, according to disclosed examples.

FIG. 3B is a rear elevation view of FIG. 3A.

FIG. 4A is a molded insert assembly for use with a frac hose clamp.

FIG. 4B is the molded insert assembly in an exploded view.

FIG. 4C is a rear elevation view of the molded insert assembly.

FIG. 5A is a perspective view of an example molded insert portion.

FIG. 5B is a top plan view of the example molded insert portion.

FIG. 5C is a side elevation view of the example molded insert portion.

FIG. 5D is a rear elevation view of the example molded insert portion.

FIG. 6 is a perspective view of a cavity mold assembly for forming a molded insert portion.

FIG. 7A is a process flow for an example method for manufacturing a molded insert assembly for a frac hose clamp.

FIG. 7B is a process flow for an example method for using a molded insert assembly in conjunction with a frac hose clamp.

Further aspects and features of the example embodiments described herein will appear from the following description taken together with the accompanying drawings.

### DESCRIPTION OF VARIOUS EMBODIMENTS

Disclosed examples generally relate to a molded insert assembly for a frac hose clamp, and a method for manufacturing and assembling thereof.

### I. General Overview

In oil and gas applications, clamps are used to secure frac hoses in position against vibrations resulting from high-pressure fluids pumped in and out of the frac hose.

In the conventional clamp design, one or more rubber inserts are disposed inside the clamp, and positioned around the frac hose. As the clamp is wider (e.g., larger) than the frac hose, the rubber inserts are used to fill the gap between the clamp interior and the hose, thereby securing the frac hose inside the clamp.

The use of rubber inserts, however, presents a number of significant drawbacks:

First, the rubber inserts often wear out and damage the outer casing of the frac hose. More particularly, friction sliding between the rubber material and frac hose—e.g., as high-pressure fluid is pumped through the hose causing the hose to vibrate—can wear out the hose's exterior. In many cases, the wearing out is to the point that the internal wire braid of the hose is visible, at which point the hose is beyond repair and is unusable. Further, when the rubber inserts wear out, the hose may also start to rub on the metal clamp, thereby causing damage quickly to the hose.

Second, the rubber inserts are typically not designed (e.g., molded) to the shape of the clamp interior, and therefore do not provide a tight fit engagement with the clamp 102. Consequently, it is possible the rubber inserts may fail to secure the frac hose in position against intensive pumping vibrations, and the rubber inserts may themselves become dislodged over time due to these intense vibrations.

In view of the foregoing, disclosed examples provide for a molded insert assembly for frac hose clamps. It is believed that the disclosed molded insert assembly mitigates at least some of the aforementioned drawbacks associated with conventional rubber inserts.

### Ii. Example Frac Hose Clamp

The following is a discussion of an exemplary frac hose clamp that can be used in conjunction with the molded insert assembly described herein.

### (i.) Clamp Design.

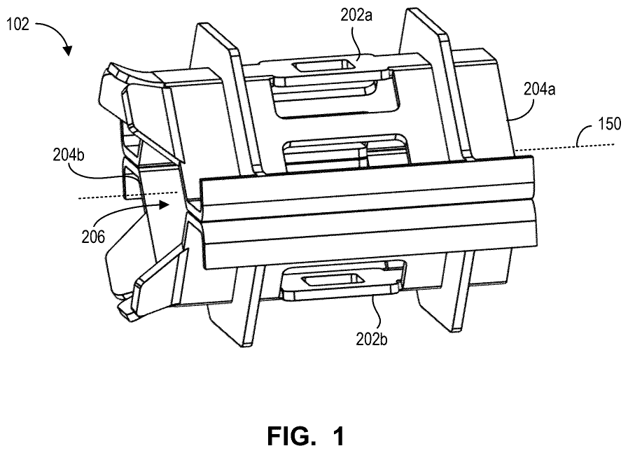

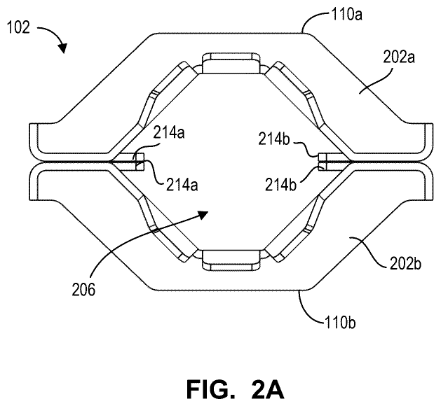

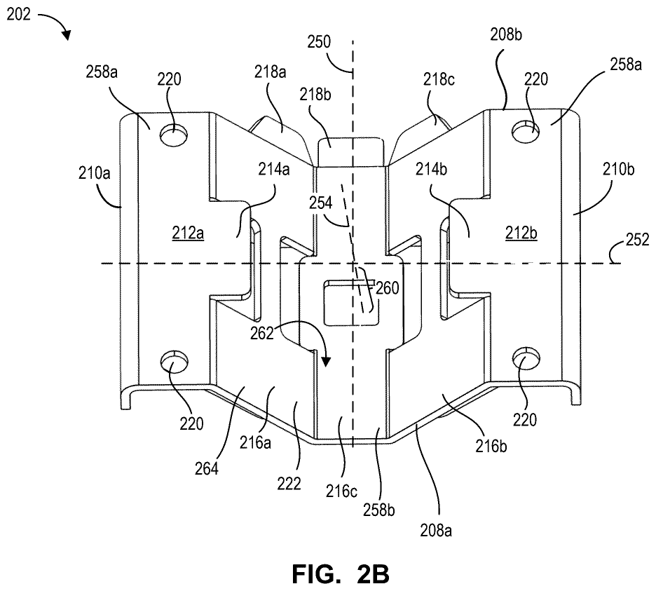

FIGS. 1-2 exemplify a frac hose clamp 102 that can be used for retaining a frac hose.

As shown in FIG. 1, the clamp 102 is typically of a two-part construction, and includes a first clamp member 202a and a second clamp member 202b. The clamp members 202a, 202b are coupled together to form the clamp 102.

As illustrated in FIG. 2A, when oriented in an upright position-clamp 102 extends between an upper end 110a and a lower end 110b. The first clamp member 202a can define the upper end 110a, while the second clamp member 202b can define the lower end 110b.

For ease of reference, the first and second clamp members 202a, 202b are accordingly referred to herein respectively as the upper clamp member 202a and the lower clamp member 202b. It is understood, however, that the clamp 102 is not limited to any particular orientation.

More generally, clamp 102 also extends between a first clamp end 204a and a distal second clamp end 204b, along a clamp extension axis 150. Each of the clamp members 202a, 202b extends along clamp axis 150, between the first and second clamp ends 204a, 204b.

In the coupled position, the clamp members 202a, 202b define a clamp opening 206. Clamp opening 206 extends through the clamp 102, along clamp axis 150, between the first and second clamp ends 204a, 204b. In use, the frac hose and rubber inserts are received through the clamp opening 206 such as to be retained within the clamp 102.

In conventional clamp assemblies, the clamp opening 206 has a generally hexagonal cross-sectional profile, e.g., as defined in a plane orthogonal to the clamp axis 150. In other examples, the clamp opening 206 may have any suitable shape (e.g., a circular cross-sectional profile).

### (ii.) Clamp Members.

FIG. 2B illustrates in greater detail the features of each clamp member 202a, 202b. While only a single clamp member 202 is exemplified, it is understood that both clamp members 202a, 202b have a generally identical design as shown in FIG. 2B.

To this end, each clamp member 202 extends between a respective first member end 208a and a second member end 208b, along a corresponding clamp member extension axis 250.

When the clamp members 202a, 202b are assembled together to form clamp 102 (FIGS. 1 and 2A), each of the first members ends 208a collectively define the first clamp end 204a. Further, each of the second members ends 208b collectively define the second clamp end 204b.

In the assembled state, the clamp members' axis 250 are oriented in parallel relation to each other, as well as to the clamp axis 150 (FIGS. 1 and 2A).

Still referring to FIG. 2B, each clamp member 202 further extends between lateral sides 210a, 210b, and along a corresponding lateral axis 252. Lateral axis 252 is generally orthogonal to the clamp portion axis 250.

A pair of engagement surfaces 212a, 212b are defined proximal each lateral side 210a, 210b. In the assembled state (FIGS. 1 and 2A), opposing engagement surfaces 212—of each clamp member 202—engage (e.g., abut) each other. This allows the upper clamp member 202a to rest on top of the lower clamp member 202b.

Each engagement surface 212 can extend a pre-defined length along the lateral axis 252, to define a lateral width dimension. As well, each engagement surface 212 can extend (e.g., span) along extension axis 250, at least partially between the front and rear member ends 208a, 208b.

To this end, each engagement surface 212a, 212b includes one or more fastening holes 220. In the assembled state (FIG. 1), the fastening holes 220—in opposing clamp members 202—align with each other to allow fasteners (e.g., nuts, bolts or the like) to be inserted therethrough. This allows securing the clamp members 202 together.

In FIG. 2B, a portion of each engagement surface 212 is shown extending inwardly—along lateral axis 252—to define a hanging tab member 214a, 214b.

As used herein, the “inward” direction refers to a direction, along lateral axis 252, directed away from the lateral sides 210a, 210b of each clamp member 202.

In each clamp member 202, a midportion 222 also extends between the front and rear members 208a, 208b. The midportion 222 further spans, along lateral axis 252, between the two engagement surfaces 212a, 212b.

In the assembled state (FIGS. 1 and 2A), the midportions 222 of clamp members 202 are directed to face each other, and collectively define the clamp opening 206.

As illustrated, the midportion 222 generally defines a concave profile, e.g., along a plane parallel to a traverse axis 254. In FIG. 2B, the midportion 222 includes two sloping segments 216a, 216b angled away from each engagement surface 212a, 212b. The sloping segments 216a, 216b intersect at a planar segment 216c. In this manner, the three segments 216a, 216b, 216c define a half hexagonal design. In other examples, the midportion 222 can define any other suitable shape (e.g., a semi cylindrical shape).

In this illustrated configuration, engagement surfaces 212a, 212b define an upper end 258a of the clamp member 202. Further, the planar segment 216c defines a lower end 258b, spaced apart from the upper end 258a along traverse axis 254.

In this manner, the midportion 222 defines an inner volume area 262 of the clamp 202, which extends along traverse axis 254 between the upper end 258a and lower end 258b, by a traverse or height distance 260. Midportion 222 also defines an inner surface 264 of the clamp member 202.

As shown in FIG. 2A, the hanging tab members 214a, 214b—in each clamp member 202—hang over the sloping segments 216a, 216b, and extend inwardly into the inner volume area 262.

As further shown in FIG. 2B, each of clamp member 202 also includes one or more dented elements 218a-218c. The purpose of the dented elements 218a-218c is to provide an angled surface to support the bending frac hose. The dented elements 218a-218c extend from the rear end 208b of each clamp member 202, and are contiguous with each of segment 216 of the midportion 222.

### Iii. Molded Insert Assembly for Frac Hose Clamp

The following is a description of a molded insert assembly that can be used alone and/or in conjunction with a frac hose clamp, such as the frac hose clamp 102.

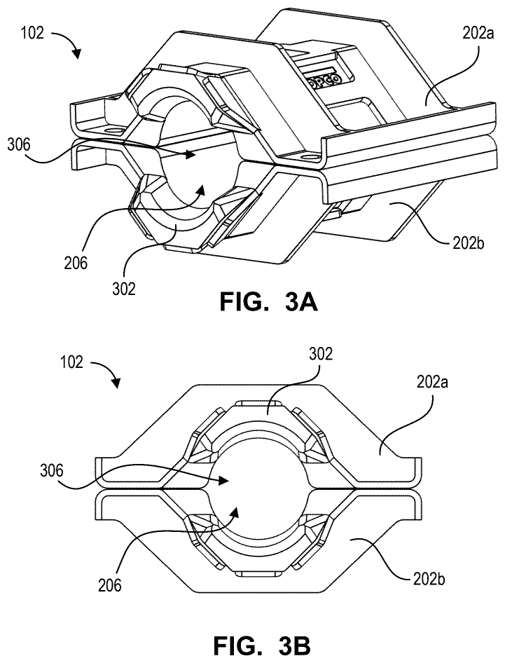

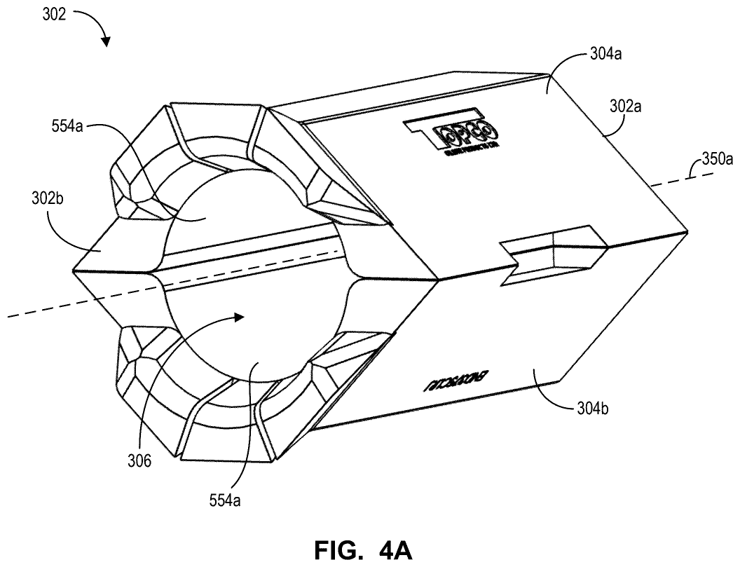

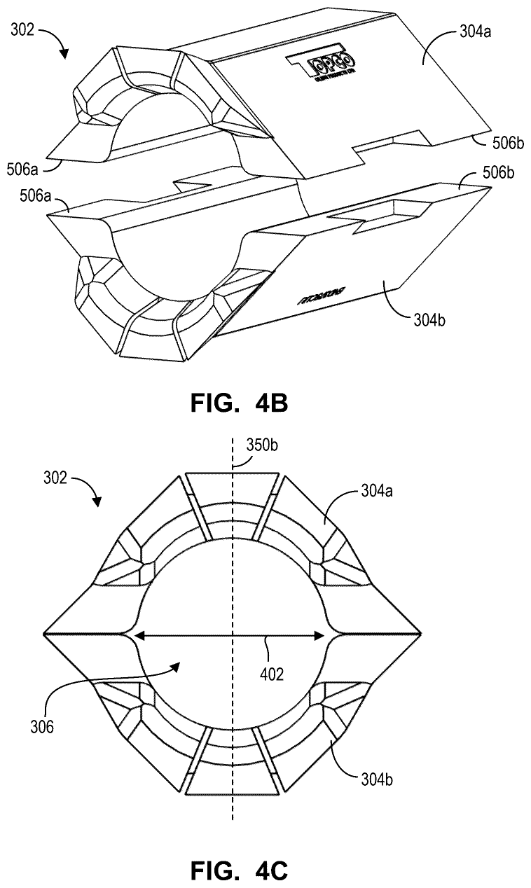

FIGS. 3-4 exemplify a molded insert assembly 302 in accordance with disclosed examples. In at least one example, the molded insert assembly 302 is used in conjunction with the frac hose clamp 102. For instance, the molded insert assembly 302 is used in the alternative of, or in addition to, conventional rubber inserts.

At a broad level, as best exemplified in FIGS. 3A and 3B, the molded insert assembly 302 is receivable within the clamp opening 206, of the clamp assembly 102.

As contrasted to the conventional rubber inserts, however, a unique feature is that the insert 302 is molded to the shape of the clamp interior. In this manner, molded insert assembly 302 is designed for a fitting engagement within clamp 102, thereby preventing it from displacement, e.g., due to high pressure vibrations of the frac hose. The molded insert 302 is also designed to take the shape of the frac hose, thereby also more securely retaining the frac hose within the clamp 102.

Another unique aspect of the disclosed molded insert 302 is that it comprises (e.g., it is fabricated or manufactured from) of a urethane material, and preferably a polyurethane material. An appreciated advantage of using polyurethane is that it reduces the amount of wear damage inflicted on the frac hose, which may be made of rubber or rubber-like material (e.g., a special elastomer compound). In particular, as contrasted to conventional rubber inserts, polyurethane has been found to minimally damage the frac hose exterior when there is friction engagement between the frac hose and molded insert 302, e.g., resulting from pressure vibrations of the frac hose. This is because polyurethane has much higher wear characteristics than rubber.

In at least one example, the molded insert 302 is formed entirely (e.g., 100%) of a urethane, and more preferably polyurethane. In other examples, the molded insert 302 is formed of a urethane or polyurethane composite. In some examples, the polyurethane is configured to resist temperatures in a range of −30° C. to 110° C. such as to withstand a range of outdoor temperatures where the frac hose may be deployed.

The molded insert assembly 302 is now described in greater detail.

### (i.) General Configuration of Molded Insert Assembly.

As shown in FIGS. 4A-4C, similar to clamp 102, the molded insert assembly 302 is also comprised of a two-part construction including: an upper insert portion 304a, and a lower insert portion 304b (FIG. 4B).

The upper and lower insert portions 304a, 304b are each molded for a fitting coupling with the corresponding upper and lower clamp members 202a, 202b (FIGS. 2A-2B). It is understood that reference to “lower” and “upper” are only for ease of reference, and disclosed examples are not limited to any particular orientation.

In an assembled state, the molded insert portions 304a, 304b engage together along an engagement axis 350b to form the molded insert assembly 302 (FIG. 4C).

As shown in FIG. 4A, upon assembly, the molded insert assembly 302 extends, along an extension axis 350a, between a front assembly end 302a and an opposed rear assembly end 302b. Extension axis 350a is orthogonal to engagement axis 350b.

When the molded insert assembly 302 is received inside of the clamp 102, the extension axis 350a is generally parallel (e.g., coterminous) with the clamp assembly axis 150 (FIG. 1). Further, the front and rear assembly ends 302a, 302b—of the molded insert assembly 302 (FIG. 4A)—are oriented in the same direction as the front and rear ends 204a, 204b of the clamp 102. In this manner, the molded insert assembly 302 is fitted inside of the clamp opening 206.

As further exemplified in FIGS. 4A and 4C, the upper and lower molded insert portions 304a, 304b together define a frac hose insertion aperture 306. The purpose of the hose insertion aperture 306 is to receive and surround the frac hose. Hose insertion aperture 306 can extend along the extension axis 350a, between the front and rear assembly ends 302a, 302b.

As shown in FIG. 4C, the insert portions 304a, 304b may be molded such that the hose insertion aperture 306 has a cross-sectional profile that matches the exterior profile of a frac hose. The cross-sectional profile may be defined along a plane orthogonal to extension axis 350a. By way of example, in FIG. 4C, the hose insertion aperture 306 can have a diameter 402 that is substantially equal to the frac hose outer diameter.

The appreciated advantage of having matching cross-sectional profiles is that the molded insert assembly 302 can securely and fittingly retain around the frac hose. This is contrasted to conventional rubber inserts, which are not molded to the frac hose's shape. The frac hose is therefore more likely to slip and slide relative to the conventional rubber inserts, thereby not only displacing the frac hose relative to the clamp 102, but also damaging the frac hose's outer casing due to friction sliding between the inserts and the hose exterior.

### (ii.) Molded Insert Portions.

The following is a discussion of each of the molded insert portions 304. Each molded insertion portion 304 can be used alone, or in conjunction with another molded insert portion 304, i.e., to form the molded insert assembly 302.

At a general level, each molded insert portion 304 is designed to have a corresponding shape and design matching each clamp member 202 (FIG. 2B). This, in turn, allows the molded insert portion 304 to couple (e.g., engage) to a respective clamp member 202, and in fitting engagement.

To this end, each molded insert portion 304 has a general design that is complementary (e.g., matches) the shape configuration of the inner volume 262 of each clamp member 202, i.e., extending between the engagement surfaces 212a, 212b of each clamp member 202, and inclusive of the clamp dented members 218 (FIG. 2B). In this manner, the molded insert portion 304 can be tightly fitted inside the inner volume 262.

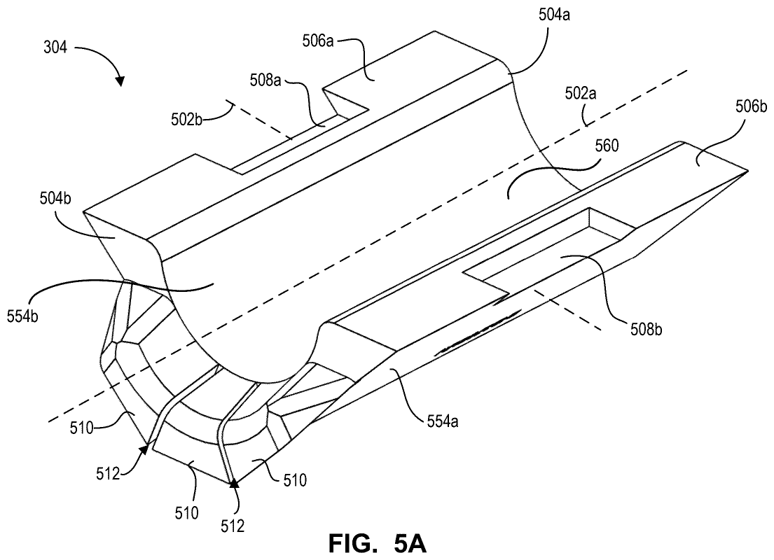

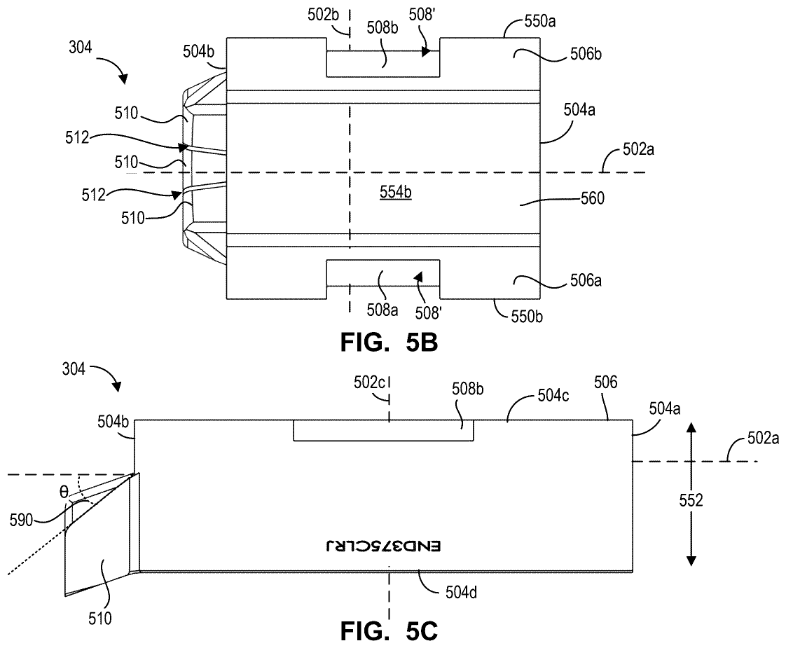

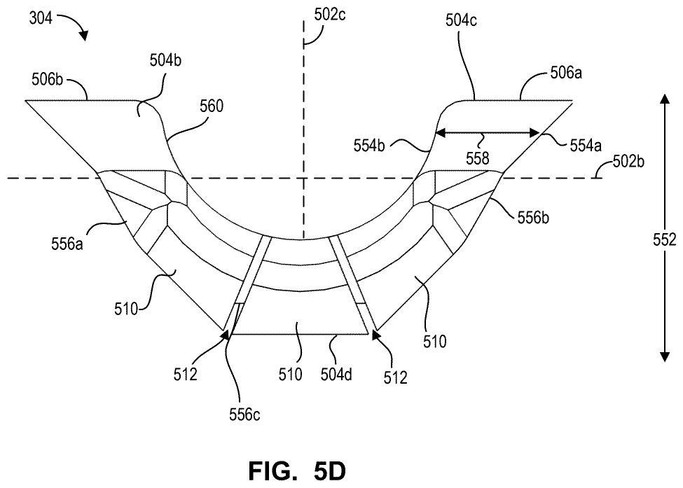

FIGS. 5A-5C exemplify a configuration for a molded insert portion 304, and showing the molded insert portion 304 from various perspective views. In some examples, the molded insert assembly 302 includes a pair (e.g., two) molded insert portion 304a, 304b that have a generally identical or mirror configuration, as exemplified in FIGS. 5A-5C.

As shown, the molded insert portion 304 extends, along an insert portion extension axis 502a, between a front portion end 504a and a distal second portion end 504b.

As exemplified in FIG. 5B, the molded insert portion 304 can also extend between lateral sides 550a, 550b and along a lateral axis 502b. Lateral axis 502b may be orthogonal to the insert portion extension axis 502a.

Various portions of the molded insert portion 304 are now described in greater detail.

### Contact Surfaces

Similar to the clamp members 202, a contact surface 506a, 506b extends inwardly from each lateral side 550a, 550b—and along lateral axis 502b—to define a lateral width dimension.

As shown in FIG. 4B, the purpose of the contact surfaces 506 is to allow the molded insert portions 304a, 304b to engage or couple to each other, e.g., along opposing contact surfaces 506a, 506b. The contact surfaces 506—on the lower molded insert portion 304b—therefore support the upper molded insert portion 304a.

In some examples, as shown in FIG. 5C, the contact surfaces 506a, 506b define an upper end 504c of the molded insert portion 304. Upper end 504c is defined along a height or traverse axis 502c, opposite to a lower end 504d. The contact surfaces 506a, 506b may be planar surfaces that extend along a common “contact” plane, to provide a level contact face.

When the molded insert portion 304 is coupled to the corresponding clamp member 202—the contact surfaces 506a, 506b are aligned along a common plane (e.g., a common horizontal plane) with the clamp engagements surfaces 212a, 212b. This, in turn, ensures that when the clamp 102 is assembled with the molded insert assembly 302 therein—the clamp members 202 and molded insert portions 304 engage (e.g., abut) each other along a uniform common plane defined by the engagement and contact surfaces. In some cases, this is achieved by configuring the molded insertion portion 304 to have a height or traverse dimension 552 (FIG. 5C)—defined along height axis 502c—that is equal to the traverse/height dimension 260 of each clamp member 202 (FIG. 2B).

### Tab-Receiving Grooves

Referring to FIG. 5B, along each lateral side 550a, 550b—a portion of the lateral side 550 is indented inwardly (e.g., cutaway) to define a tab-receiving groove 508a, 508b.

When the molded insert portion 304 is coupled to the clamp member 202—the grooves 508a, 508b are sized, positioned and dimensioned to fittingly receive the corresponding hanging tab member 214a, 214b in the clamp member 202 (FIG. 2B).

In at least one example, this mating engagement between the tab members 214 and the grooves 508 is to ensure that the molded insert portion 304 is positionally secured inside the clamp member 202. That is, the mating engagement between the two elements ensures that the molded insert portion 304 is not displaced relative to the clamp member 202, e.g., due to vibrations of the frac hose, which is a drawback of the conventional rubber inserts.

As exemplified, the grooves 508 extend, along lateral axis 502b, into the contact surfaces 506a, 506b. Further, the groves 508 have an open end 508′—for receiving the tab members 214—and extending along a portion of the lateral sides 550.

### Exterior and Interior Surfaces

Referring to FIGS. 5A, 5B and 5D, the molded insert portion 304 includes an exterior surface 554a and an interior surface 554b.

In the coupled position, exterior surface 554a engages the inner clamp surface 264 (FIG. 2B), which defines the clamp's midportion 222. Clamp midportion 222 is the portion extending between the two engagement surfaces 212a, 212b of each clamp member 202, and includes the dented members 218.

To provide a fitting engagement, the exterior surface 554a can have a complementary shape and size configuration, as the clamp midportion 222. For example, the exterior surface 554a can have a semi-hexagonal shape, similar to the semi-hexagonal shape of the clamp midportion 222 (FIG. 2B). In other examples, the exterior surface 554a may have any other shape complementary to the clamp midportion 222 (e.g., a semicircular shape).

To this end, as shown in FIG. 5D, exterior surface 554a can have two sloping sides 556a, 556b which intersect at a flat or planar side 556c. The sloping sides 556a, 556b may have the same sloping angle and dimension as the clamp's sloping segments 216a, 216b (FIG. 2A). Further, the planar side 556c can have the same lateral width and dimension as the planar segment 216c in the clamp member 202 (FIG. 2B).

Continuing with reference to FIGS. 5A, 5B and 5D, the interior surface 554b of the molded insert portion 304 can define a “hose-receiving surface” 560, as well as the contact surfaces 506a, 506b.

In use, the hose-receiving surface 560 defines a surface over which the frac hose is overlaid. In the assembled state (FIG. 4A), the hose-receiving surfaces 560—of each molded insert portion 304—are directed to face each other to define the hose insertion aperture 306.

As shown in FIG. 5B, the hose-receiving surface 560 can extend, along lateral axis 502b, between the two contact surfaces 506a, 506b. Further, hose-receiving surface 560 can generally extend, along extension axis 502a, between the front and rear portion ends 504a, 504b.

As exemplified in FIG. 5D, the hose-receiving surface 560 can have a concave cross-sectional profile, defined along a plane parallel to the height axis 502c. In the illustrated example, the hose-receiving surface 560 defines a generally semi-circular concave profile. In this manner, when the molded insert portions 304a, 304b are assembled together (FIG. 4A), the opposing hose-receiving surfaces 560 define a circular cross-sectional profile that matches and mates with the exterior of the frac hose.

### Thickness Dimension

As exemplified in FIG. 5D, the molded insert portion 304 can have a thickness dimension 558 defined between the outer and inner surfaces 554a, 554b.

In at least one example, the thickness 558 is such that—when the molded insert assembly 302 is received inside the clamp 102—the molded insert assembly 302 fills the negative space (e.g., void) between the inner surface of the clamp 102, and the exterior of the frac hose. This ensures the molded insert assembly 302 securely retains the frac hose inside the clamp 102.

### Sloped Members

The rear portion end 504b—of the molded insert portion 304—may further includes one or more sloped members 510 (FIGS. 5B and 5C). The sloped members 510 may extend from the rear portion end 504b, and may have one side that is contiguous with the hose-receiving surface 560 (FIG. 5B).

When the molded insert portion 304 is coupled to the clamp member 202, the sloped members 510 are shaped, sized and oriented to rest over (e.g., overlay) the dented elements 218 (FIG. 2B). This provides protection for the portion of the frac hose that is resting over the dented elements 218.

In at least one example, the molded insert portion 304 includes an equal number of sloped members 510, as dented elements 218 in the clamp member 202. Accordingly, each sloped member 510 aligns with a corresponding dented element 218 in the coupled position.

Further, as exemplified in FIGS. 5B and 5D, the sloped members 510 can have an interspacing 512—e.g., defined along lateral axis 502c—that is equal to the interspacing between the clamp's dented elements 218. Again, this ensures that in the coupled position, each sloped member 510 positionally aligns with the corresponding dented element 218.

As best shown in FIG. 5C, the sloped elements 510 can be angled by a corresponding angle 590 (θ), defined relative to a plane parallel to the extension axis 502a. Angle 590 can be substantially the same as the angle at which dented elements 218 (FIG. 2B) of the clamp members are sloped. This ensures that the sloped elements 510 can correctly overlay the dented elements 218.

In some examples, there may be no interspacing 512 between the sloped elements 510. For example, only a single sloped member 510 can be provided. This may be useful if the clamp member 202 itself includes only a single dented element 218.

### Alternative Configurations

While the exemplified embodiments illustrate a two-part molded insert assembly 302 (e.g., portions 304a and 304b)—in other examples, the assembly 302 may comprise any number of portions. For example, it may be molded as a single integrated portion (e.g., portions 304a, 304b are molded as a single integrated portion), or three or more portions, while maintaining the same shape configuration.

### (iii.) Cavity Mold Assembly for Forming Molded Insert Portion.

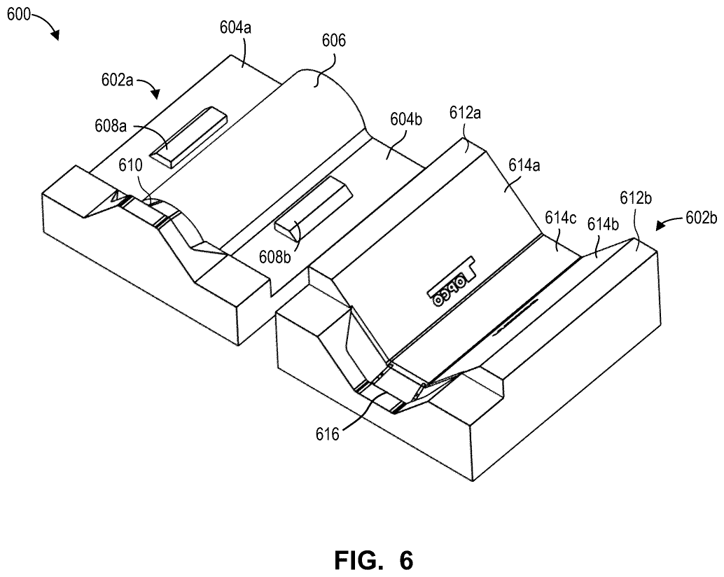

FIG. 6 exemplifies a cavity mold assembly 600 used to mold a molded insert portion 304.

The cavity mold assembly 600 includes two parts: (i) a first cavity mold 602a, used to mold the interior surface 554b, of the molded insert portion 304 (also referred to herein as the “interior cavity mold” 602a), and (ii) a second cavity mold 602b, used to mold the exterior surface 554a of the molded insert portion 304 (also referred to herein as the “exterior cavity mold” 602b).

With respect to the interior cavity mold 602a—as exemplified, it includes a design that is complementary (e.g., inverse) to the interior surface 554b of the molded insert portion 304. For example, it includes two planar surfaces 604a, 604b that form the contact surfaces 506a, 506b on the molded insert portion 304 (FIGS. 5A-5C). Each planar surface 604a, 604b also includes a protrusion 608a, 608b that is used to form the tab-receiving grooves 508a, 508b (FIG. 5A). Additionally, a convex portion 606 extends between the planar surfaces 604a, 604b and is used to form the hose-receiving surface 560. In some examples, the convex portion 606 has a cylindrical shape design. This allows the molded insert portion 304 to take the shape of the frac hose exterior. At least one end of the interior cavity mold 602a also includes a sloped molded configuration 610 for forming the sloped members 510.

With respect to the exterior cavity mold 602b—as also exemplified, it also includes a design that is complementary (e.g., inverse) to the exterior surface 554a of the molded insert portion 304. The exterior cavity mold 602b includes one or more planar surfaces 612a, 612b for also forming the contact surfaces 506a, 506b. Between the planar surfaces 612a, 612b are one or more angled and planar surfaces 614a-614c for forming the sloping and planar sides 556a-556c of the molded insert portion 304 (FIG. 5D) (e.g., the semi-hexagonal shape). At least one end of the exterior cavity mold 602b also includes a sloped molded configuration 616 for forming the sloped members 510.

In an assembled state, the interior cavity mold 602a is fitted over the exterior mold 602b, such that: (i) the convex portion 606 of the interior mold 602a is directed towards the surfaces 614a-616c of the exterior mold 602b; and (ii) the sloped molded configurations 610, 616, in each cavity mold, are aligned along the same end. This allows for forming each of the molded insert portions 304.

In other examples, the cavity mold assembly 600 can have any number of parts to form any corresponding number of molded portions, as desired.

### Iv. Example Methods

The following is a discussion of various example methods for manufacturing and using the molded insert portions.

### (i.) Example Method of Manufacturing Molded Insert Portions.

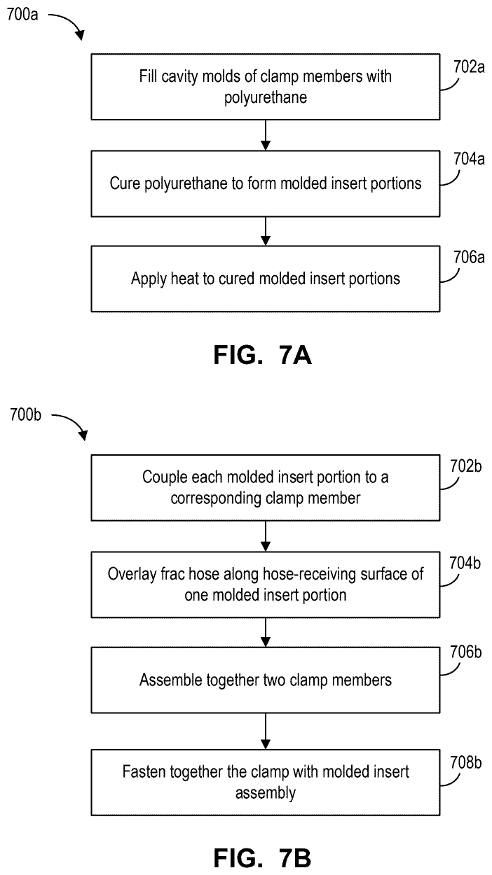

FIG. 7A shows a process flow for an example method 700a for manufacturing the molded insert portions 304.

At 702a, the cavity mold assembly 600 (FIG. 6)—for each clamp members 202—is assembled and filled with polyurethane material.

In at least one example, prior to filling the assembled cavity mold with polyurethane, and assembling the cavity molds 602a, 602b—the cavity molds 602a, 602b are initially heated to a processing temperature (e.g., 100° C./212° F.). In some examples, the cavity molds 602a, 602b are also initially treated with release agents.

In still other examples, also prior to filling the assembled cavity mold 600 with polyurethane, the polyurethane is prepared as follows: (i) a prepolymer is preheated (e.g., 85° C./185° F.); (ii) in some examples, pigment is added to the prepolymer for desired coloring; (iii) a curative is heated to a processing temperature (115° C./240° F.); and (iv) the polyurethane is prepared by adding the curative to the prepolymer and mixing thoroughly.

At 704a, the polyurethane material, in each cavity mold assembly 600, is cured to form the molded insert portions 304. In some examples, the polyurethane inside the cavity mold assembly 600 is cured for 30 to 60 minutes.

At 706a, each cured part is removed from the cavity mold assembly 600 and is further heated. In some examples, the heating occurs for a target period of time (e.g., 16 hours) and at a target curing temperature (e.g., 100° C./212° F.), e.g. inside of the oven. The molded insert portions 304 are then removed to cool. In some examples after cooling, the molded insert portions 304 are trimmed to remove excess material, e.g., from the mold joints.

In various examples, the molded insert portions are formed of 100% polyurethane that can be formulated to various hardness (durometer) levels.

(ii.) Example Method of Using and/or Assembling Molded Insert Portions.

FIG. 7B shows a process flow for an example method 600b for using or assembling the molded insert portions 304.

At 702b, each of the molded insert portions 304 is coupled to a corresponding clamp member 202 in a coupled position. This includes fitting (e.g., inserting) each molded insert portion 304 into the inner volume area 262 of each clamp member 202.

In the coupled position, the front and rear ends 504a, 504b of each molded insert portion 304 (FIG. 5A), are oriented in the same direction as the front and rear ends 208a, 208b of each clamp member 202 (FIG. 2B). Further, the hanging tab members 214, in each clamp member 202 (FIG. 2B), are received into the corresponding tab-receiving grooves 508, on the molded insert portions 304 (FIG. 5A). This ensures a secure fit between the two elements.

At 704b, the frac hose is laid along the hose-receiving surface 554b (FIG. 5A), of a first molded insert portion 304, i.e., which is coupled to the corresponding clamp member 202.

At 706b, the second clamp member 202—having a coupled second molded insert portion 304—is then mounted over the first clamp member, as exemplified in FIGS. 3A and 3B.

In this assembled state, the engagement surfaces 212a, 212b—of each clamp member 202—abut (e.g., engage) each other. Further, the contact surfaces 506a, 506b—of each of the molded insert portions—also abut each other. In this configuration, the frac hose is received through the hose insertion aperture 306 of the molded insert assembly 302 (FIGS. 3A and 3B).

At 708b, the clamp members can be fastened together to form the assembled clamp 102, with the molded insert assembly 302 disposed therein. For example, one or more fasteners are threaded through the fastening holes 220 of clamp 102 (FIG. 2B).

### V. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A molded insert assembly for use with a frac hose clamp, the molded insert assembly comprising a pair of molded insert portions, each molded insert portion comprising:
a forward end and an opposed rear end, extending along an extension axis, as well as a first lateral side and a second lateral side opposed along a lateral axis orthogonal to the extension axis;
a pair of contact surfaces spanning along either lateral side, wherein the contact surfaces extend along a contact plane;
each contact surface comprising a tab-receiving groove having an open end defined along the corresponding lateral side;
a hose-receiving surface extending, along the lateral axis, between the pair of contact surfaces, and further extending between the forward and rear ends,
wherein the hose-receiving surface has a cross-sectional concave profile extending from the contact plane and along a traverse axis; and
one or more sloped members, extending from the rear end, each of the sloped members disposed at an angle to the surface.

2. The assembly of claim 1, wherein the molded insert portions are each formed of polyurethane material.

3. The assembly of claim 1, wherein the molded insert portions assemble together in opposing configuration to form the molded insert assembly,
wherein in the assembled state, the pair of contact surfaces in the molded insert portions engage each other, and the front and rear ends of each molded insert portion are oriented in the same direction along the extension axis.

4. The assembly of claim 3, wherein in the assembled state, the extension axis of each of the molded insert portions are arranged in parallel orientation.

5. The assembly of claim 1, wherein in the assembled state, the hose-receiving surface of each of the molded insert portions define a hose insertion aperture for receiving the frac hose.

6. The assembly of claim 1, wherein the hose-receiving surface has a semicircular cross-sectional profile.

7. The assembly of claim 6, wherein in the assembled state, the hose-receiving surface of each of the molded insert portions define a cylindrical hose insertion aperture for receiving the frac hose.

8. The assembly of claim 7, wherein the hose insertion aperture has a diameter substantially equal to the diameter of the frac hose such as to provide a fitting engagement between the frac hose and the molded insert assembly.

9. The assembly of claim 1, wherein the one or more sloped members provide an angled surface for supporting a bending of the frac hose.

10. The assembly of claim 1, wherein the frac hose clamp comprises a pair of clamp members, and each molded insert portion is molded to the shape of an inner volume of a corresponding one of the clamp members.

11. The assembly of claim 10, wherein each molded insert portion is couplable to a clamp member in a coupled position.

12. The assembly of claim 11, wherein in the coupled position, the tab-receiving groove on each molded insert portion receives a corresponding tab member of the clamp member to secure the molded insert portion to the clamp member.

13. The assembly of claim 10, wherein in the coupled position, the sloped members overlay dented elements of the clamp member.

14. The assembly of claim 13, wherein the sloped members, of each molded insert portion, have a sloping angle and interspacing that is substantially the same as a sloping angle and interspacing of the dented elements in corresponding clamp member.

15. The assembly of claim 1, wherein the molded insert assembly has a thickness dimension that fills a negative space between an inner surface of the hose clamp and an outer casing of the frac hose.

16. A method of manufacturing a molded insert assembly used with a frac hose clamp, the method comprising:
filling a pair of cavity molds with polyurethane, wherein each cavity mold is designed with a cavity shaped to form a molded insert portion according to claim 1; and
curing the polyurethane in each cavity mold to form a pair of molded insert portions.

17. The method of claim 16, further comprising removing the molded insert portions from the cavity molds.

18. A method of assembling a frac hose clamp with molded insert portions, comprising:
coupling a pair of molded insert portions, according to claim 1, to a corresponding pair of clamp members of the frac hose clamp;
overlaying a frac hose along the hose-receiving surface of one of the coupled molded insert portions; and
assembling the clamp members to form the clamp with a molded insert assembly therein, wherein in an assembled state, the frac hose extends through a hose insertion aperture of the molded insert assembly.

19. The method of claim 18, wherein the assembled state, the clamp members engage together along corresponding engagement surfaces.

20. The method of claim 19, further comprising fastening together the clamp members.
